(19) United States
(12) Patent Application Publication
(10) Pub. No.: US 2006/0079113 A1
(43) Pub. Date: Apr. 13, 2006

(54) Electrical connector spacer

(75) Inventor: Steven E. Minich, York, PA (US)

Correspondence Address: HARRINGTON & SMITH, LLP, 4 RESEARCH DRIVE, SHELTON, CT, 06484-6212, US

(73) Assignee: FCI Americas Technology, Inc.

(21) Appl. No.: 10/964,129

(22) Filed: Oct. 13, 2004

(51) Int. Cl. H01R 13/64

(52) U.S. Cl. 439/378

(57) ABSTRACT

An electronic component assembly includes a first electronic component, a second electronic component, and a grommet. The first electronic component includes a first electrical connector and at least one guide post. The second electronic component includes a printed circuit board, a second electrical connector having signal contacts connected to the printed circuit board with a ball grid array connection, and at least one guide post receptacle. The grommet is on the guide post. The guide post is adapted to be inserted into the guide post receptacle with the grommet providing a resilient spacer for buffering forces on the ball grid array connection when the first electrical connector is connected to the second electrical connector.

### BACKGROUND OF THE INVENTION

1. Field of the Invention

The present invention relates to electrical connectors and, more particularly, to a spacer for an electrical connector.

2. Brief Description of Prior Developments

U.S. Pat. No. 6,065,992 discloses a guide post of an electrical connector. A coil spring is provided on the guide post. There is a desire for a buffering element similar to the spring in U.S. Pat. No. 6,065,992, but which is smaller, less expensive and easier to assemble.

### SUMMARY OF THE INVENTION

In accordance with one aspect of the present invention, a guide post associated with a first electrical connector is provided for guiding the first connector into mating engagement with a second electrical connector, the guide post comprising a post section which is insertable into the receptacle hole of a guide post receptacle and a grommet mounted to the post section for providing a resilient force between the two connectors when mating the connectors together. The grommet is preferable made from a pliable, compressible, resilient, and elastomeric material such as plastic, rubber, fire proof fabric or felt pads, etc.

In accordance with another aspect of the present invention, an electronic component assembly is provided comprising a first electronic component, a second electronic component, and a non-metallic grommet. The first electronic component comprises a printed circuit board, a first electrical connector having signal contacts connected to the printed circuit board with a ball grid array connection and at least one guide post. The second electronic component comprises a second electrical connector and at least one guide post receptacle. The non-metallic grommet is positioned on the guide post, wherein the guide post is adapted to be inserted into the guide post receptacle with the grommet providing a resilient spacer for buffering forces on the ball grid array connection when the first electrical connector is connected to the second electrical connector.

### BRIEF DESCRIPTION OF THE DRAWINGS

The foregoing aspects and other features of the present invention are explained in the following description, taken in connection with the accompanying drawings, wherein:

FIG. 1 is an exploded perspective view of an electronic component assembly incorporating features of the present invention;

FIG. 2 is an enlarged view of a portion of the assembly shown in FIG. 1;

FIG. 3A is a perspective view of one of the electrical connectors shown in FIG. 1;

FIG. 3B is a perspective view of a bottom side of the electrical connector shown in FIG. 3A;

FIG. 4 is an enlarged view of one of the connections of the electrical connector shown in FIGS. 3A and 3B to the printed circuit board; and

FIG. 5 is an assembled view of the assembly shown in FIG. 1.

### DETAILED DESCRIPTION OF THE PREFERRED EMBODIMENT

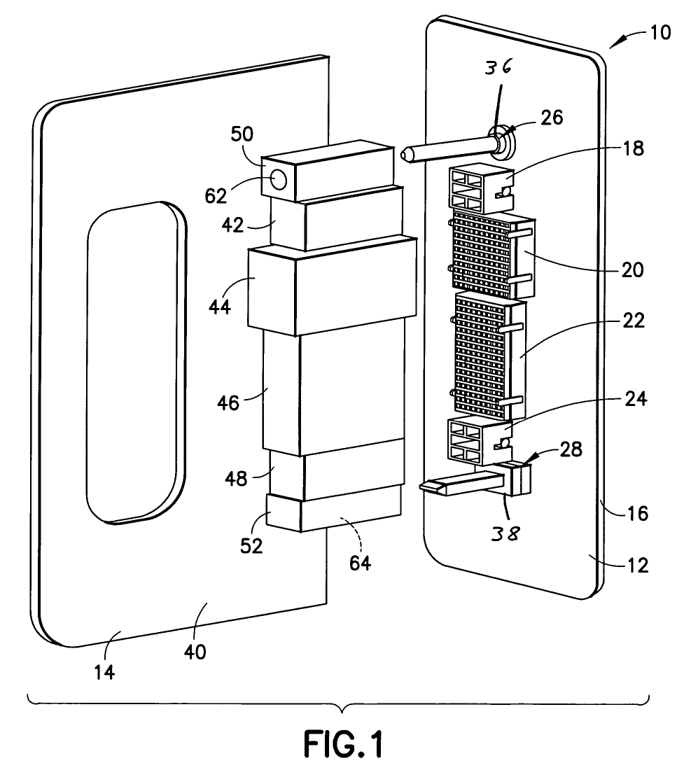

Referring to FIG. 1, there is shown an exploded perspective view of an electronic component assembly 10 incorporating features of the present invention. Although the present invention will be described with reference to the exemplary embodiment shown in the drawings, it should be understood that the present invention can be embodied in many alternate forms of embodiments. In addition, any suitable size, shape or type of elements or materials could be used.

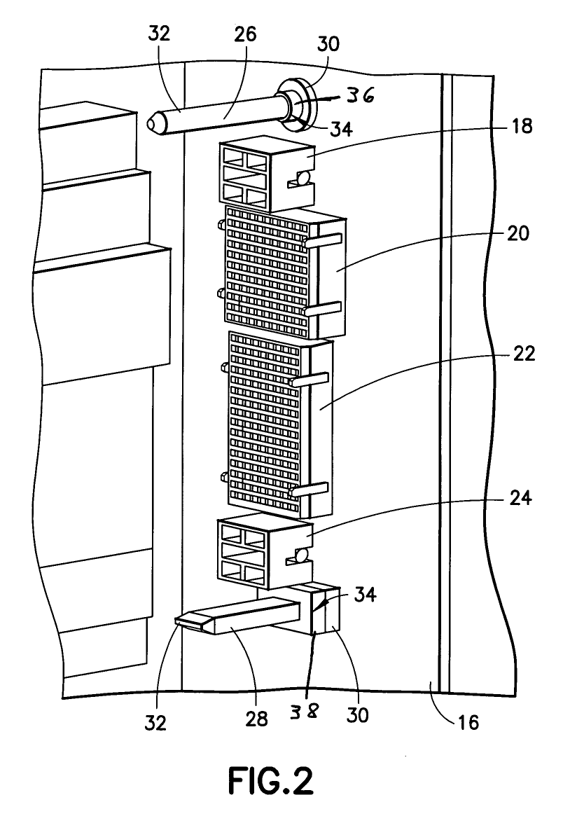

The assembly 10 generally comprises a first electronic component assembly 12 and a second electronic component assembly 14. Referring also to FIG. 2, the first electronic component 12 generally comprises a first printed circuit board 16, electrical signal connectors 20, 22, first electrical power connectors 18 24, and guide posts 26, 28. In alternate embodiments, any suitable number or size electrical connector(s) and/or guide post(s) could be provided, and the guide post(s) could be integrally formed with one or more of the electrical connectors. In addition, any suitable electronic component rather than the first printed circuit board could be provided.

In the embodiment shown in FIGS. 1 and 2, the two guide posts 26, 28 have different cross sectional shapes. Each guide post 26, 28 has a base section 30 and a post section 32. The base section 30 is mounted to the first printed circuit board 16. The post sections 32 have a smaller cross sectional size than the base sections. Therefore, a seat 34 is formed at the junction of the base section with the post section. Each guide post 26, 28 is provided with a grommet 36, 38. The grommets 36, 38 are located around the post sections 32 and sit on the seats 34. The grommets 36, 38 may also have an inner diameter that is equal to or smaller than the outer diameter of the post section, 32, the base section, or seat 34 so that the grommets stay in place through frictional engagement with the guide posts 26, 28. The grommets are comprised of a resilient polymer material and may have a general O-ring shape. In general, the grommets 36, 38 protect surface mount solder connections on the backplane and daughtercard by helping to absorb mating forces that act on the electrical connectors during mating. No additional attachments, other than friction, are needed to retain the grommets with respect to the guide posts 26, 28. Moreover, the grommets are inexpensive to manufacture or purchase and are plentiful on the open commercial market.

As seen best in FIG. 1, the second electronic component 14 generally comprises a second printed circuit board 40, second electrical connectors 42, 44, 46 and 48 such as power and signal connectors, and guide posts receptacles 50, 52. In alternate embodiments, any suitable number or size electrical connector(s) and/or guide post receptacle(s) could be provided, and the guide post receptacle(s) could be integrally formed with one or more of the electrical connectors. In addition, any suitable electronic component rather than the second printed circuit board could be provided.

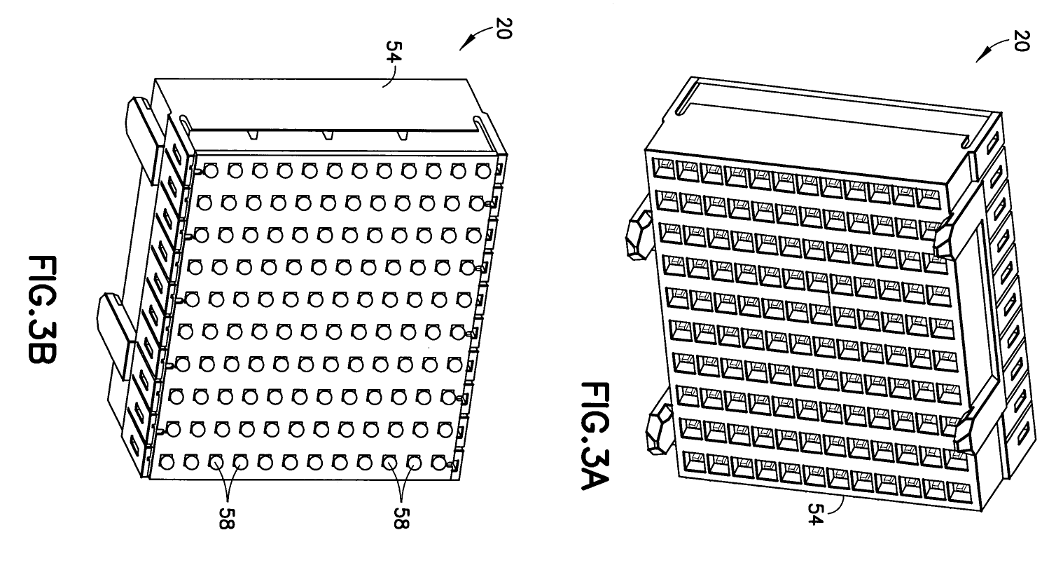

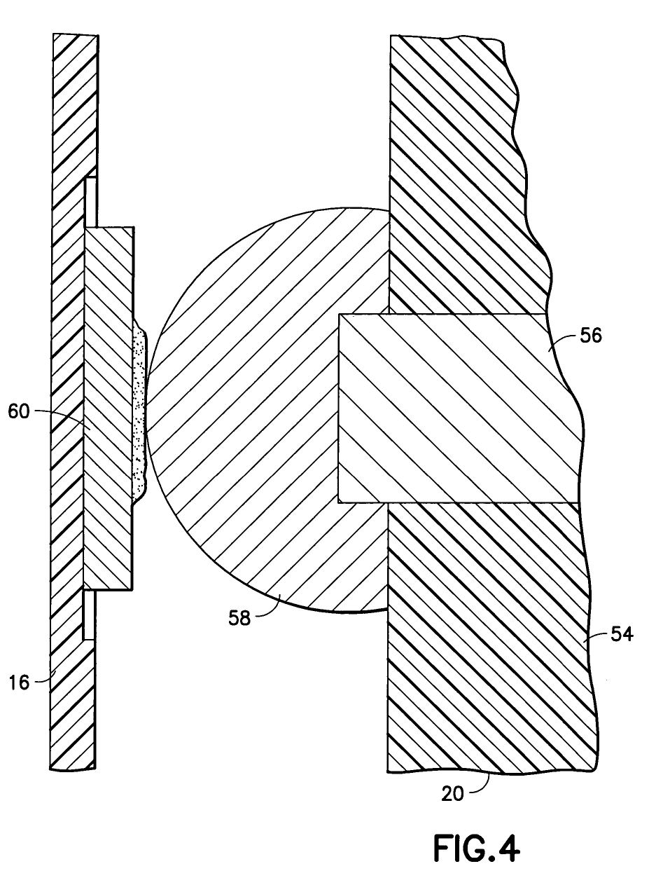

Referring also to FIGS. 3 and 4, one of the first electrical connectors 20, in this instance a signal receptacle connector, is shown. The first electrical connector generally comprises a housing 54, signal contacts 56 and an array of fusible elements 58 on tails of the signal contacts 56. The fusible elements 58 are melted and subsequently cool to form a mechanical and electrical connection with solder pads 60 on the first printed circuit board 16. This forms a ball grid array (BGA) connection between the signal contacts 56 of the connector 20 and the first printed circuit board 16. Any surface mount connector can be attached to the first or second printed circuit boards using BGA or other surface mount technology.

The guide post receptacles 50, 52 are stationarily attached to the second printed circuit board 40. The guide post receptacles 50, 52 each comprise a slot 62, 64 for receiving the guide posts 26, 28, respectively. The guide posts 26, 28 and slots 62, 64 insure aligned mating of the first connectors 18-24 with the second connectors 42-48.

As noted above, the assembly comprises the grommets 36, 38 on the guide posts 26, 28. When the guide post receptacles 50, 52 are mounted on the guide posts 26, 28, the leading edges of the guide post receptacles 50, 52 contact the grommets 36, 38. The grommets perform multiple functions. The grommets function as resilient members to provide a buffering force to the mating operation. Thus, the connectors are protected against damage caused by the mating force. The housings of the mating connectors are prevented from contacting each other by the grommets providing a spacer function. Thus, forces of the mating housings contacting each other, which might cause damage to the soldered connections, is avoided.

With a conventional coil spring, such as in U.S. Pat. No. 6,065,992, the springs are contacted and deformed by the post receiving housing relatively early in length of travel. The force of the coil springs being deformed increases along the length during deformation and is stored or maintained always exerting a force against the post receiving housing. Thus, the coil springs constantly produce a force to push the mating electrical connectors apart. The grommets of the present invention, on the other hand, are able to provide this buffering function in a much smaller area and over a much smaller insertion length than a conventional coil spring or leaf spring. Therefore, resistance force in a direction opposite to the insertion force does not start until much later in the mating process (compared to a conventional coil spring or leaf spring), which can help reduce insertion force and help eliminate or minimize a restoring force stored in the grommet. Thus, the grommets of the present invention do not have the same problems as the coil springs in U.S. Pat. No. 6,065,992. The restoring force for the grommets of the present invention would act to push the two mated connectors apart only along a relatively very small length compared to coil springs.

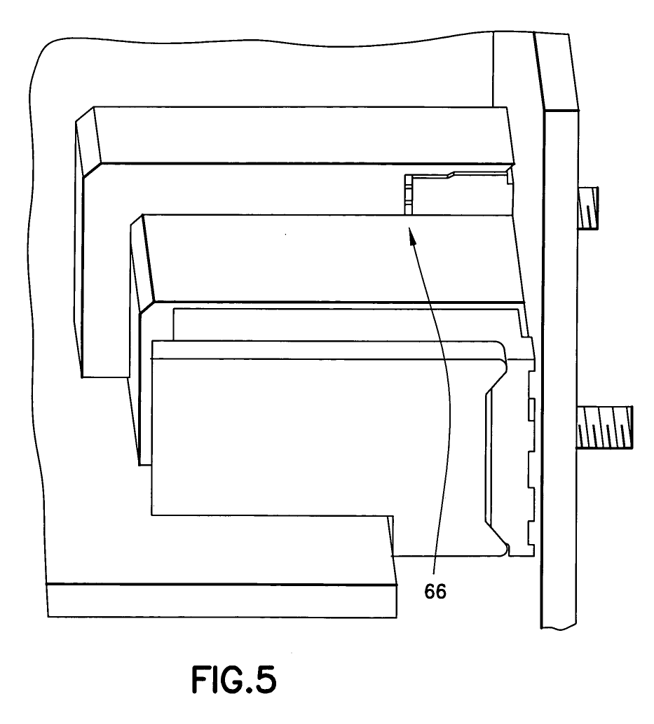

Referring also to FIG. 5, the grommets 36, 38 can also provide a small gap 66 between the mating faces of at least the connectors 20 and 44. This reduces the stress and strain on the fused connections by the fusible elements 58 between the signal contacts 56 and the pads 60. Thus, the fused connections are less likely to be damaged during the connection operation of the second electronic component assembly 14 to the first electronic component assembly 12.

The relatively small size of the grommets 36, 38 allow the buffering system of the present invention to be used in connection with smaller size electrical connectors which might have smaller lengths of connection areas. Grommets are less expensive to manufacture than small size coil springs and are easier to assemble on a post than small size coil springs. A grommet can also provide a sealing function if desired; whereas a coil spring could not.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. An electrical connector guide post assembly associated with a first electrical connector for guiding the first connector into mating engagement with a second electrical connector, the guide post assembly comprising a post section which is insertable into the receptacle hole of a guide post receptacle in a first direction and a resiliently deformable grommet mounted to the post section for providing a resilient force between the two connectors along the first direction when mating the connectors together, wherein the grommet is adapted to be compressed along the first direction to provide the resilient force in the first direction.

2. The guide post as claimed in claim 1 wherein the grommet is made from a non-metallic material.

3. An electronic component assembly comprising:
a first electronic component comprising a printed circuit board, a first electrical connector having signal contacts connected to the printed circuit board with a ball grid array connection and at least one guide post;
a second electronic component comprising a second electrical connector and at least one guide post receptacle; and
a non-metallic resiliently deformable grommet positioned on the guide post, wherein the guide post is adapted to be inserted into the guide post receptacle with the grommet being compressed to form a resilient spacer between portions of the first and second electrical connectors for buffering forces on the ball grid array connection when the first electrical connector is connected to the second electrical connector.

4. A guide post assembly as in claim 1 wherein the grommet comprises an O-ring.

5. An electronic component assembly as in claim 3 wherein the grommet comprises an O-ring.

6. An electronic connector assembly comprising:
a first electrical connector having signal contacts and at least one guide post; and
at least one non-metallic resiliently deformable grommet positioned on the at least one guide post, wherein the grommet has a general O-ring shape, wherein the guide post is adapted to be inserted into a guide post receptacle of a mating electrical connector with the grommet being compressed to form a resilient spacer between portions of the electrical connectors.

7. An electrical connector assembly as in claim 6 wherein the grommet comprises a general round shape.

8. An electrical connector assembly as in claim 6 wherein the grommet comprises a general rectangular shape.

9. An electrical connector assembly as in claim 6 wherein the at least one guide post comprises two guide posts and the at least one grommet comprises two grommets located on respective ones of the guide posts.

10. An electrical connector assembly as in claim 9 wherein the grommets comprise different shapes.

11. An electrical connector assembly as in claim 10 wherein a first one of the grommets comprises a general round shape and a second one of the grommets comprises a general rectangular shape.
